(19) United States
(12) Patent Application Publication
(10) Pub. No.: US 2022/0240062 A1
(43) Pub. Date: Jul. 28, 2022

(54) METHOD, SYSTEM, AND APPARATUS FOR SECURE EXCHANGE OF SOCIAL MEDIA INFORMATION

(71) Applicant: IMIDASTOUCH LLC, Wilmington, DE (US)

(72) Inventors: Michael Shaun Gurayah, Los Angeles, CA (US); Robert Ryan, Los Angeles, CA (US)

(21) Appl. No.: 17/572,591

(22) Filed: Jan. 10, 2022

Related U.S. Application Data
(60) Provisional application No. 63/135,621, filed on Jan. 10, 2021.

(51) Int. Cl. H04W 4/21; H04W 4/80; H04W 76/14; H04W 12/50

(52) U.S. Cl. CPC H04W 4/21; H04W 12/50; H04W 76/14; H04W 4/80

(57) ABSTRACT

A method of securely exchanging social media information includes displaying, on a display of a first mobile device, a profile associated with a user of a second mobile electronic device. The profile omits at least one item of information. The method also includes sending, from the first mobile electronic device, a connection request to the second mobile electronic device and displaying, on the display of the second mobile device, the profile including the at least one omitted item of information in response to the user of the second mobile electronic device accepting the connection request.

### CROSS-REFERENCE TO RELATED APPLICATION(S)

This application claims priority to and the benefit of U.S. Provisional Application No. 63/135,621, filed Jan. 10, 2021, the entire contents of which are incorporated herein by reference.

### BACKGROUND

### 1. Field

The present disclosure relates to systems, methods, and apparatuses for securely exchanging information.

### 2. Description of Related Art

Sharing information, such as business information or social media information, is typically done manually. For instance, at networking events such as tradeshows, attendees typically manually exchange physical business cards. However, it is cumbersome and time-consuming to later enter that information into a mobile electronic device. Additionally, physical business cards are prone to being lost and they typically do not include profile pictures. Accordingly, users are prone to forgetting those individuals they meet at networking events. Moreover, conventional attempts to facilitate the electronic exchange of personal information at networking events are susceptible to abuse and exploitation and can result in privacy intrusions or violations.

### SUMMARY

The present disclosure relates to various embodiments of systems and methods for the secure exchange of information. In one embodiment, the method includes displaying, on a display of a first mobile electronic device, a profile associated with a user of a second mobile electronic device. The profile omits at least one omitted item of information. The method also includes transmitting, from the first mobile electronic device, a connection request to the second mobile electronic device. The method further includes displaying, on the display of the second mobile device, the profile including the at least one omitted item of information in response to the user of the second mobile electronic device accepting the connection request.

A method according to another embodiment of the present disclosure includes displaying, on a display of the first mobile electronic device, a profile associated with a user of a second mobile electronic device in response to the first mobile electronic device being within a geofenced area set by the second mobile electronic device. The method also includes joining, by the first mobile electronic device, an exclusive community associated with the user of the second mobile electronic device.

A method according to a further embodiment of the present disclosure includes activating or tapping an NFC medallion on a mobile electronic device. The branded NFC medallion is associated with a community. The method also includes displaying, on a display of the mobile electronic device, a series of members of the community.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a method, system, or apparatus for the secure exchange of information.

### BRIEF DESCRIPTION OF THE DRAWINGS

The features and advantages of embodiments of the present disclosure will be better understood by reference to the following detailed description when considered in conjunction with the drawings.

FIGS. 1A-1B are rear and front views, respectively, of a first mobile electronic device including a near field communications (NFC) tag;

FIG. 2 is a system for securely exchanging information according to one embodiment of the present disclosure;

FIG. 3 is a flowchart of a method for securely exchanging information according to one embodiment of the present disclosure;

FIG. 4 schematically depicts two mobile electronic devices securely exchanging in three different manners depending on whether both devices have tokens, only one device has a token, or neither device has a token;

FIG. 5A depicts two mobile electronic devices securely exchanging information based on one device scanning a QR code;

FIG. 5B depicts a flowchart of a method of two electronic devices securely exchanging information by scanning a QR code;

FIG. 6A depicts two mobile electronic devices securely exchanging information based on the two devices being within range of a short-range wireless technology standard;

FIG. 6B depicts a flowchart of a method of two electronic devices, which are within range of a short-range wireless technology standard, securely exchanging information; and

FIG. 7 is a view of a mobile electronic device displaying an options menu for selecting a “public” mode; a “private” mode; an “anonymous” mode; or off;

FIG. 8 is a view of a first mobile electronic device displaying a landing page of a user of second mobile electronic device when in “public” mode;

FIG. 9 is a view of a first mobile electronic device displaying options for a user of the first mobile electronic device to connect with a user of a second mobile electronic device, including various digital cards of the user of the first mobile electronic device;

FIG. 10 is a view of a first mobile electronic device displaying a profile of a user of a second mobile electronic device when in “Private” mode;

FIG. 11 is a view of a first mobile electronic device displaying options for a user of the first mobile electronic device to connect with a user of a second electronic device when in “Private” mode (and other user has the app);

FIG. 12 is a view of a first mobile electronic device displaying a profile of a user of a second mobile electronic device when in “Anonymous” mode;

FIG. 13 is a view of a first mobile electronic device displaying options for a user of the first mobile electronic device to connect with a user of a second electronic device when in “Anonymous” mode;

FIG. 14 is a view of a first mobile electronic device displaying a plurality of profiles of users operating mobile electronic device within range of a short-range wireless technology standard;

FIGS. 15A-15B are views of a first mobile electronic device displaying a plurality of stored profile connections;

FIGS. 16A-16B are views of a first mobile electronic device displaying a plurality of groups;

FIGS. 17A-17B are views of a first mobile electronic device displaying a messaging feature;

FIG. 18 is a view of a mobile electronic device displaying users within a geofenced area according to one embodiment of the present disclosure;

FIG. 19 is a front view of a license plate frame including NFC technology, QR code technology, and/or Bluetooth technology according to one embodiment of the present disclosure; and

FIG. 20 is a view of a first mobile electronic device displaying a “join community” button.

### DETAILED DESCRIPTION

Each of the additional features and teachings disclosed below can be utilized separately or in conjunction with other features and teachings to provide a method, system, and apparatus for secure exchange of information (e.g., social media information). Representative examples of the following embodiments, will now be described in further detail with reference to the attached drawings. This detailed description is merely intended to teach a person of skill in the art details for practicing the preferred aspects of the teachings and is not intended to limit the scope of the embodiments.

The disclosed embodiments, comprise a hardware device capable of allowing near field communication between mobile devices, a software application capable of managing the flow of data, communications, storage, user interfaces, and control of the hardware device and user information (for devices/servers/cloud/app store/etc). Also, a system comprising both the hardware (“Mydas” or “Mydas token” or “Medallion”) device and the software application (“Mydas” “app”).

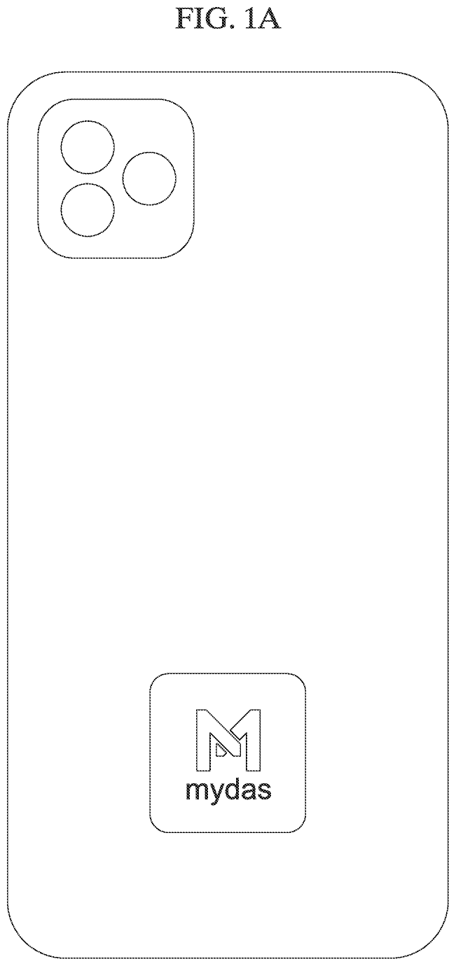

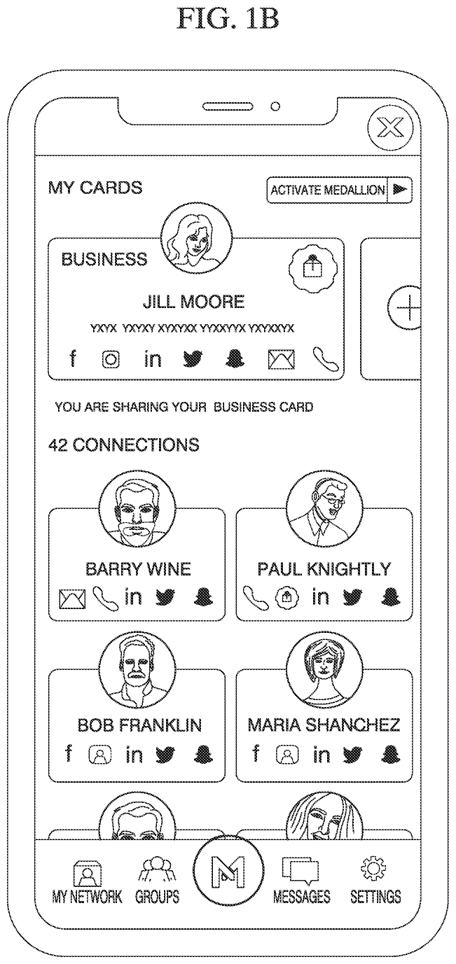

FIGS. 1A-1B depict a mobile electronic device (e.g., a smart phone) including an

NFC device (Mydas token or medallion) on a rear surface thereof. In an embodiment, the hardware device (Token, Medallion) may be semi-water proof and configure to be applied to a mobile device using an adhesive. The token may be applied to a convenient location, such as, the back of a mobile phone. The token may also be in other forms of hardware/attachables and fit for other locations beyond the phone. For example, on a watch, wristband, wearable device etc. The token may be configured to allow near field communications between mobile electronic devices. A variety of attaching mechanisms for the token to a mobile are envisioned and within the scope of this disclosure. For example, the token may be built into a phone's protective shell/case.

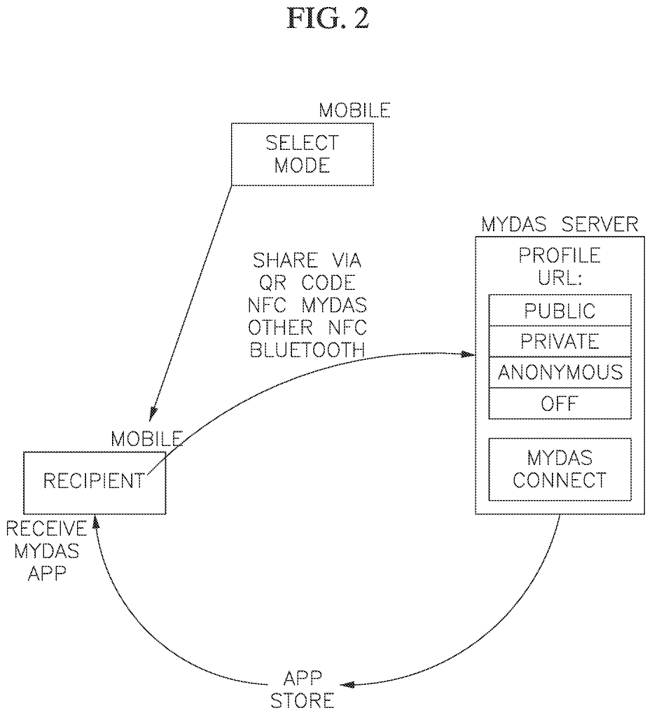

FIG. 2 depicts a system for sharing information between a first mobile electronic device and a second mobile electronic. A software application (using iOS or Android) may utilize near field communications (NFC) such as Bluetooth™, QR codes, PAN, BAN, NAN, CAN, WLAN, MWN, barcodes, UHF, RFID, or the equivalent. The software application may allow users to seamlessly share social media and contact information associated with “cards.” The sharing and managing of the user information shared may be managed via

URL's that may be connected with a specific web server (“Mydas server”) which may utilize deep deferred linking. A user may select which mode they wish to use to share information. A user may initiate the sharing of information if at least one device is using a Mydas near field exchange device (token) or software application. Depending on the mode a variety of possible connection configurations may exist.

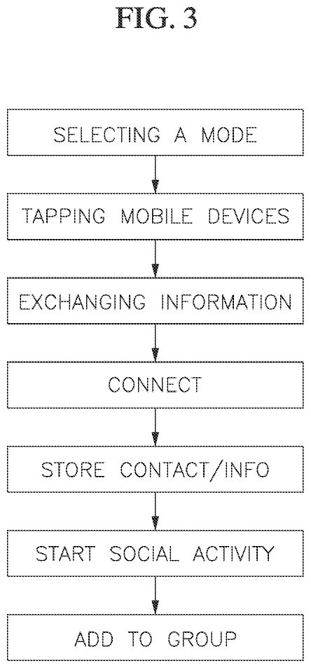

FIG. 3 depicts a flowchart illustrating tasks of sharing information according to one embodiment of the present disclosure. In the illustrated embodiment, the method includes selecting a mode (e.g., private, public, anonymous, or off); tapping a first mobile electronic device to a second electronic device (at least one of which includes an NFC tag); exchanging information between the first and second mobile electronic devices; connecting profiles; storing contact information; staring a social activity (e.g., messaging); and adding a user to a group. If one of the mobile electronic devices does not have the Mydas app installed, the task of connecting the mobile electronic devices includes clicking a button that, utilizing deep deferred linking, prompts the user to download the Mydas app and then connects the users. The connection is then stored in the user's personal network, which facilitates social activity between the users. Each of these tasks are described in more detail below.

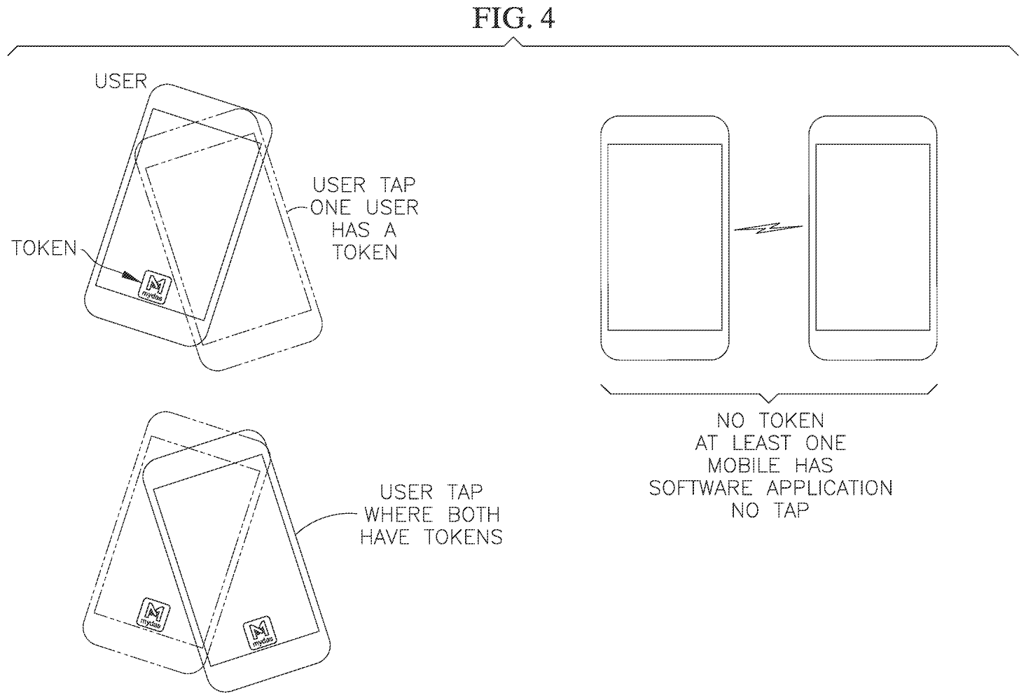

FIG. 4 depicts a series of different potential configurations of a first mobile electronic device (operated by User A) and a second mobile electronic device (operated by User B). In an embodiment, User A device may comprise a token (NFC) device and User B has no software application or token device. In an embodiment, User A device may have a Token (NFC) device and User B may have a token (NFC) device. In an embodiment, neither User A nor User B may have a token (NFC) device, but at least one user has the software application to being a connection. In an embodiment, User A has the software application and no token (NFC) device, and User B has neither token nor software application. In an embodiment, User A has the software application with Bluetooth on and User B has the software application with Bluetooth on.

In an embodiment, the flow of the information shared may be as follows: the data may be driven from a URL. The URL may be going to a specific web server (Mydas server) and the specific web server may send a user an option via a button that may say something to the effect “Connect in Mydas.” This button may be using deferred deep linking technology to keep track of the source of where the invitation was requested. This may provide more security and privacy.

In an embodiment, the software application may have a plurality of modes. In an embodiment, there may be four main modes: Public, Anonymous, private mode, and off. These four main modes may give users control of different levels of security depending on the mode and may dictate what the recipient user would see on the landing page. An advantage of using URL's for the flow of information may be greater security. A user may select a mode then tap their device (e.g. mobile phone) to another user's mobile device to initiate the exchange of information (or a connection). Or a user may scan another user's QR code (if no NFC). Once connected, a user has the option to either start a conversation (or a social activity) through in-app messaging or add that user to a group they created. A user may store the connections in a customizable way. A user may have the ability to adjust their profile and may have it correspond directly with the hardware disclosed, NFC product or QR codes. This identity may contain information related to social media, personal contact information, bios and the name of that user.

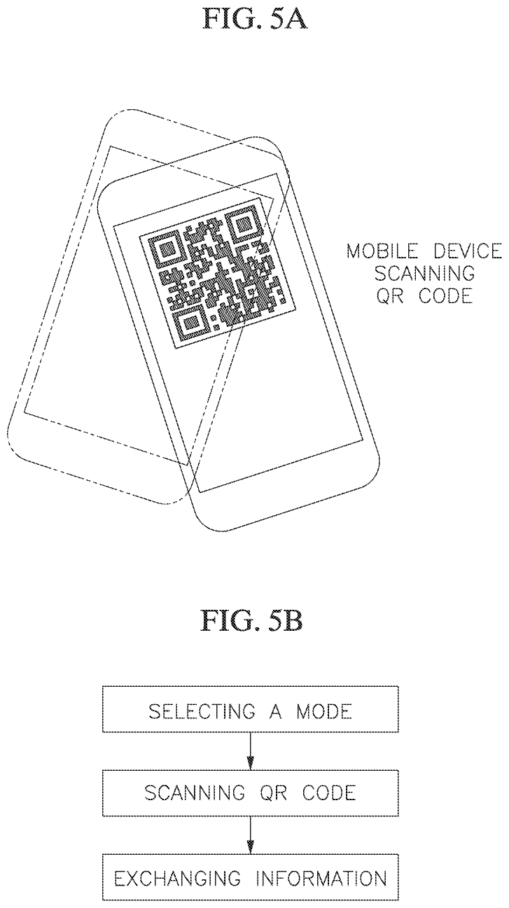

In an embodiment, the selected modes may utilize a near field (NFC) link or QR codes scanning. Using NFC or QR codes may provide a user with a webpage if the user doesn't have a copy of the software application (Mydas) running. Also, if the user has a copy of the software app, it may take the user to an in-app specific connection screen (after a QR code scan, NFC tap, etc.). FIG. 5A depicts a first mobile electronic device scanning a QR code displayed on a display of a second mobile electronic device. FIG. 5B depicts a flowchart of a method of exchanging information. In the illustrated embodiment, the method includes selecting a mode (e.g., public, private, anonymous, or off); scanning a QR code; and exchanging information.

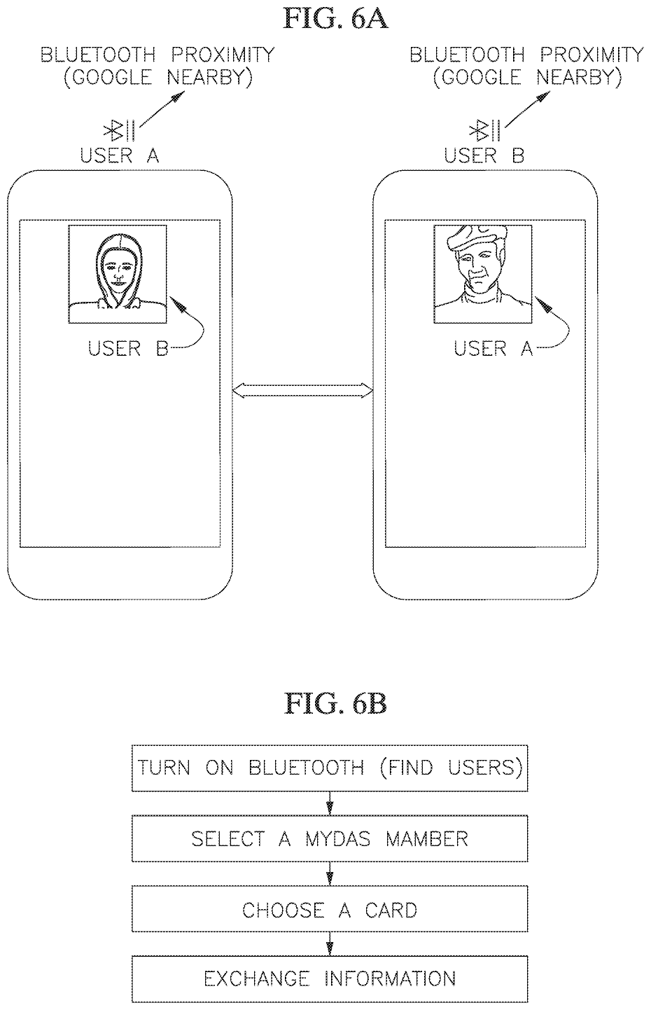

FIG. 6A depicts a first mobile electronic device connecting to a second mobile electronic device via a short-range wireless technology standard (e.g., Bluetooth™). FIG. 6B depicts a flowchart of a method of exchanging information. In the illustrated embodiment, the method includes enabling a short-range wireless technology standing (e.g., turning on Bluetooth™); selecting a member within a range of the short-range wireless technology standard; choosing a “digital card” (i.e., a business or personal profile) to share with the second mobile electronic device; and exchanging information with the second mobile electronic device.

### i) Public Mode

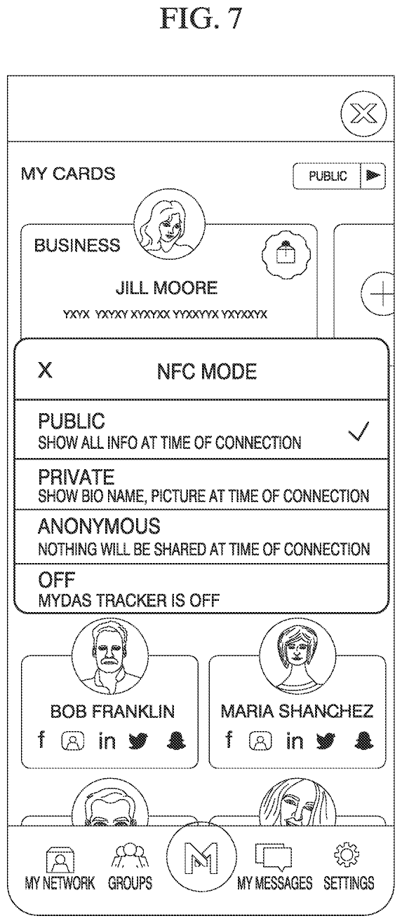

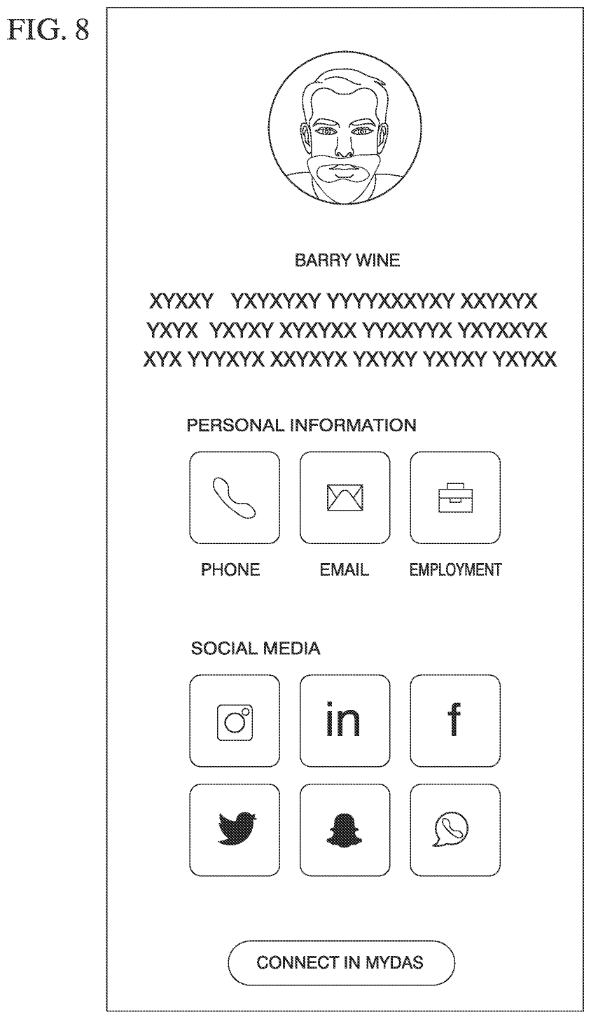

With reference now to the embodiment illustrated in FIG. 7, a user with NFC device running the software application has a user menu in which they can select the desired mode (e.g., public mode, private mode, anonymous mode, or off). If a user selects public mode using NFC exchange, then User B may receive a web page with the respective profile and the ability to connect in the app. In an embodiment, the public mode may act as follows: when User A's mobile device taps User B's mobile device (contains NFC Mydas product (hardware & software)), User A may receive a notification and the ability to view User B's landing page. User A does not need the Mydas app for this transaction to occur. Here they can click on the respective icons. For example, If User A taps on the Instagram icon, it may take them to User B's Instagram. FIG. 8 illustrates User B's landing page when in public mode.

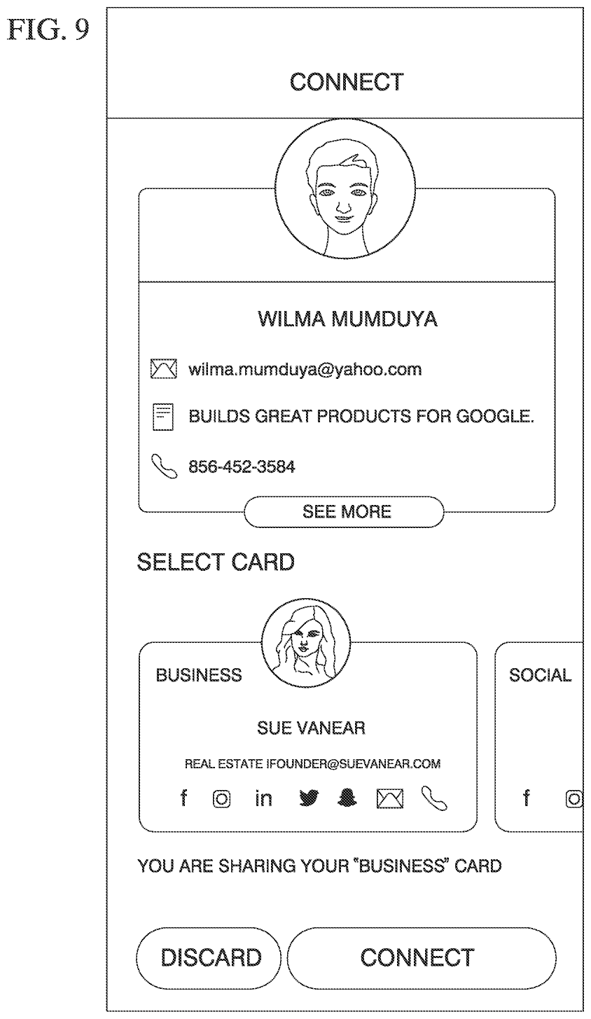

If User A clicks on “Connect in Mydas”, it may lead to User A downloading the app (utilizing deferred deep linking), creating a digital card (e.g., a business or professional profile) and then sending a connection request with the selected card. Deferred deep linking refers to the process of linking to a specific page within an app even if the user does not have the app installed on his or her mobile electronic device. Accordingly, if User A does not have the Mydas app installed on User A's mobile electronic device, when User A clicks on the “Connect in Mydas” button, User A will be directed to a digital app store to download the Mydas app, and then once the Mydas app is installed, User A will be automatically directed to User B's landing page in the Mydas app. In this manner, deferred deep linking includes memory of User B's landing page even if User A does not have the Mydas app installed. If they don't want to share information, they don't have to and they may select the discard button. FIG. 9 depicts User A's option for sharing one of User A's cards (described below) with User B.

### ii) Private Mode

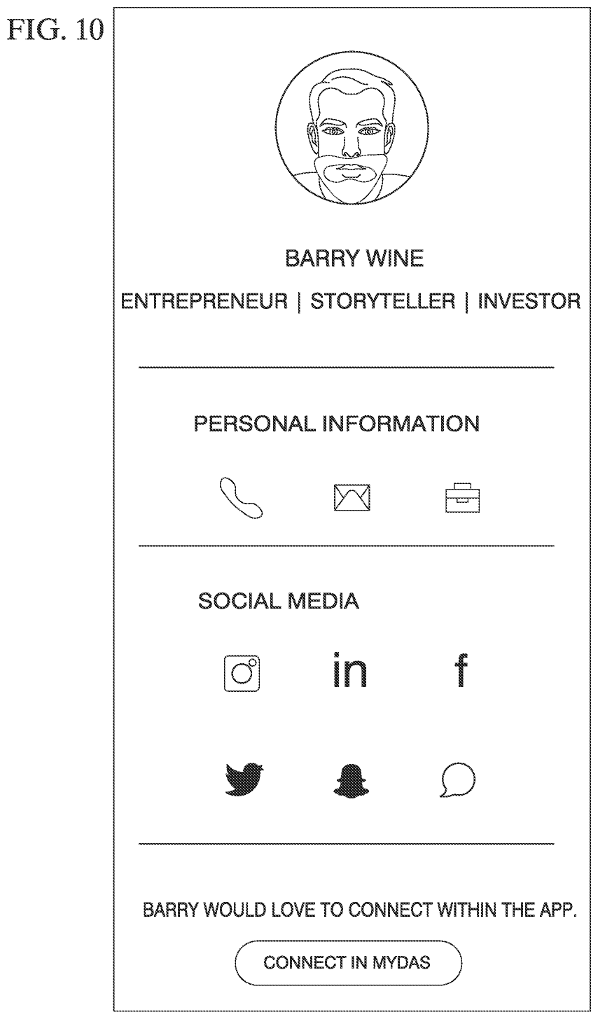

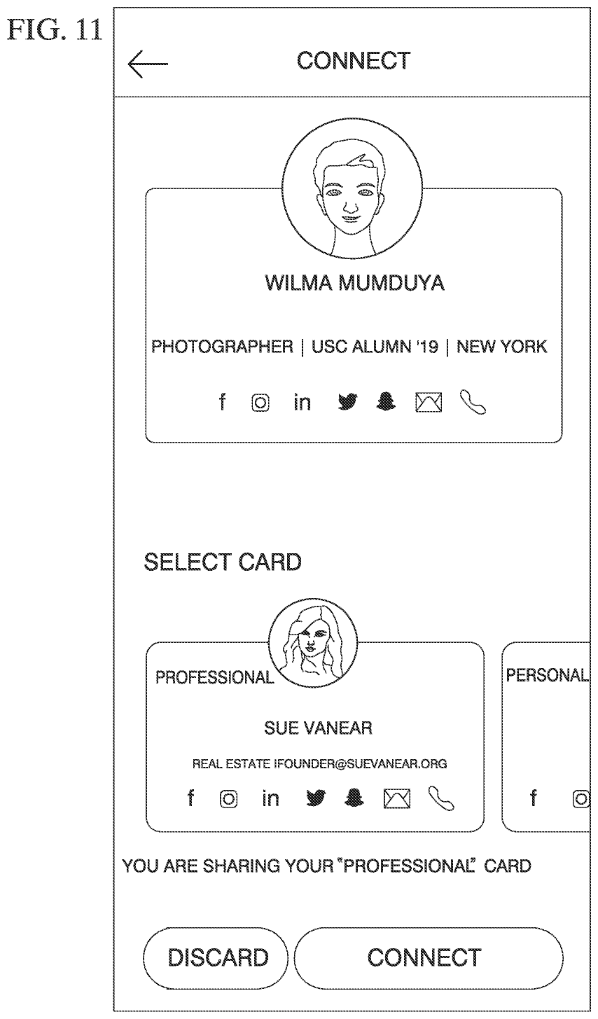

In an embodiment, in private mode, when User A's mobile device taps User B's mobile device (contains NFC Mydas and software), User A may receive a web page containing just the name, profile picture, bio, icons shown on profile (only available to view once connection request is accepted). FIGS. 10-11 depict what User A may see if User B is in private mode. If User A wants to connect with User B and get consent to access their information, User A may have to click on “Connect in Mydas” (utilizing deferred deep linking if User A does not have the Mydas app installed on User A's mobile electronic device) and may have to send a connection request to User B. User B may have the option to reject this connection request or accept this connection request to have a mutual consented connection. In this manner, private mode may provide for more security than the public mode described above.

iii) Anonymous Mode

If User A is using anonymous NFC mode exchange, then User B may see a webpage with an anonymous profile picture and an anonymous name. If User B would like to exchange information with User A, they may download the app and send a request to view this user's information/identity. In an embodiment, using anonymous mode, when User A's mobile device taps User B's mobile device (contains NFC Mydas product), User A may receive a web page with no name and just icons shown on a profile, which may be available to view only once the connection request is accepted.

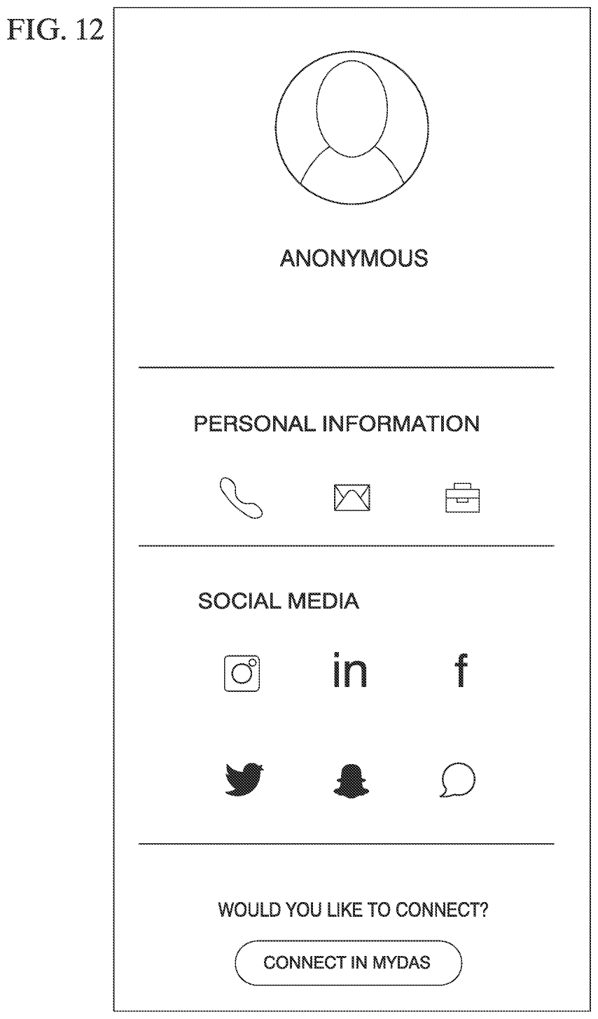

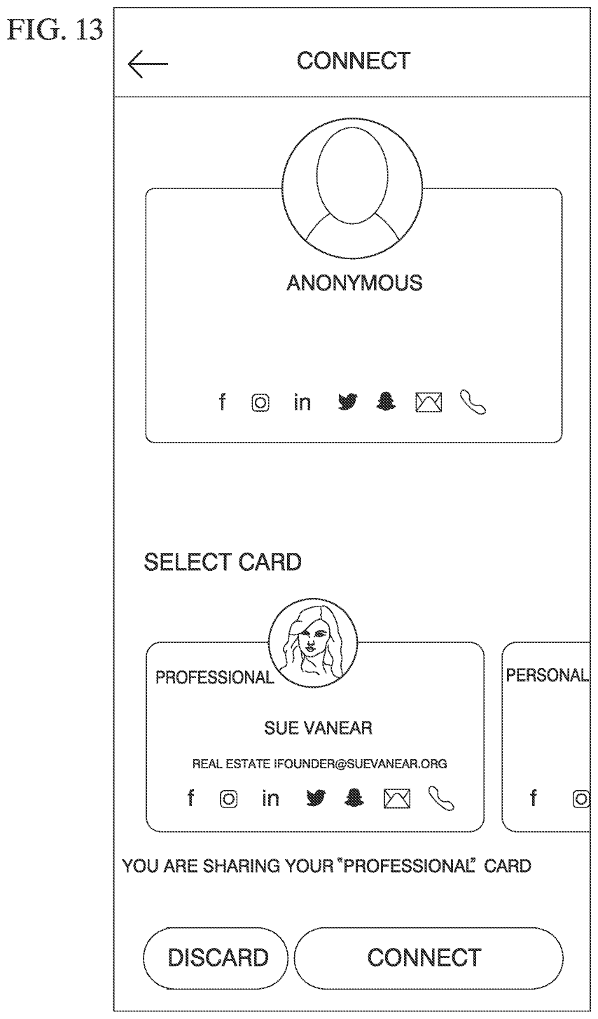

If User A wants to connect with User B and get consent to access their information, User A may have to click on “Connect in Mydas” (utilizing deferred deep linking if User A does not have the Mydas app installed on User A's mobile electronic device) and may have to send a connection request to User B. User B may have the option to reject this connection request or accept this connection request to have a mutual consented connection. FIGS. 12-13 depict what User A's mobile electronic device displays when User

B is in anonymous mode. In this manner, anonymous mode provides even greater privacy than the private mode described above.

### iv) Off

If User A is using OFF mode, then the NFC tag may be unavailable for exchanging. In an embodiment, using the OFF mode, a user may be unable to share information when the NFC is off—even if the NFC device on the phone is tapped. Even though the URL may still be there, the recipient may receive a cryptic URL. For example, the recipient may receive a landing page with no association to the user who is in the off mode.

### Cards

A user may have unlimited digital cards per account. As used herein, a “digital card” or “card” refers to a profile of a user, such as a user's business profile (e.g., work title, company, and work contact information) or a user's social profile (e.g., social media links and social media handles). In an embodiment, each user may have the ability to create and customize “cards” that may contain information such as:
Name
Photo
Video
Company
User Name
Bio
Hometown
Phone Number
Email Address
Employment and Employment history
Education
Organizations
Any social media platform
Website
URL link groups
Or any social media information a user may desire to share

In an embodiment, a user may look through and select a card. For example, a User may swipe between cards and a gold color or other highlighting may appear around the card selected to indicate its selection. Of course, other methods of looking through and selection are envisioned in the embodiment/s. In an embodiment, a gold card that may be selected, may be the card chosen and associated with the NFC tag (URL link).

### Bluetooth™

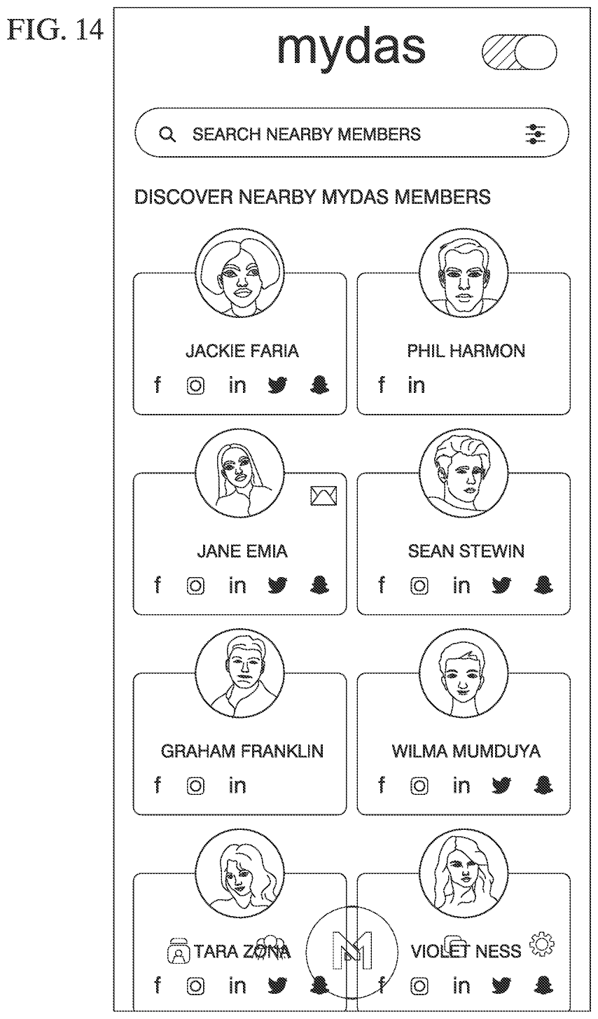

In an embodiment using Bluetooth the functionality may follow a similar private mode approach. With Bluetooth, a Mydas user (has software application) may be able to see other users around them within a particular proximity (e.g., within range of a short-range wireless technology standard, such as Bluetooth™). FIG. 14 depicts what is displayed on the display of a user's mobile electronic device when in short-range wireless range of other users. No information may be accessed by the public except maybe, for example, their bio and social media platform icons on their presenting profile. If a user is in “ghost mode” (Bluetooth is off), they may not be seen by users in Bluetooth range and may also not be able to see other users. If User A met User B and wanted to connect via Bluetooth proximity, then User A may send User B a connection request and User B may have the option to reject or accept to add that connection to their network.

In an embodiment using Bluetooth, a URL may not be exchanged, but it may be the same information that would be contained in a URL. The payload may contain, for example, a username, a card, and a security authentication key. Using an authentication key may be a secure way of exchanging information via Bluetooth. In this embodiment, information may be only readable by people running Bluetooth in the disclosed software application (“Mydas” “app”) (using an authentication key). The software application (Mydas) may use Bluetooth proximity (e.g., Google Nearby™) that may allow people to see other Mydas users that are near them. A user may have the ability to click on another Mydas profile card and send them a card of their selection when connecting. For example, if a user is at a large conference or tradeshow, the user can exchange information and store connections with, for example, 50+ individuals in less than a minute.

### QR Codes

In an embodiment using QR codes, a User may have the ability to share information through QR codes. A mobile electronic device may scan a QR code. The Mode+card selected may dictate how this information will be shown (displayed). Some features of QR embodiment include: (i) Sharing specific “cards” through a share sheet (airdrop, sms, email, etc.); (ii) Mydas web server may contain deferred deep linking technology; and (iii) User Friendly URL's using handles for posting on other social media platforms, such as (a) Profile. mydas. me/mgurayah/personal?=token→Profile. mydas. me/mgurayah/personal (Public Mode); b) Profile.mydas.me/mgurayah?=token→Profile.mydas.me/mgurayah (Private Mode); Profile. mydas. me/anonymous?=token→Profile. mydas. me/anonymous (Anonymous Mode).

In an embodiment, a card feature may allow users to have various cards associated with their respective identities and share them according to what situation they are in: e.g. Business, Social, Tradeshow.

### Storing Connections

In an embodiment, each person that you connect with, may automatically get stored in your personal network. On the personal network, a user may be able to see any information that was on the recipient's card, date of connection, notes of the connection, reminders, calendar invitations, or any feature desirable for social media networking, etc.

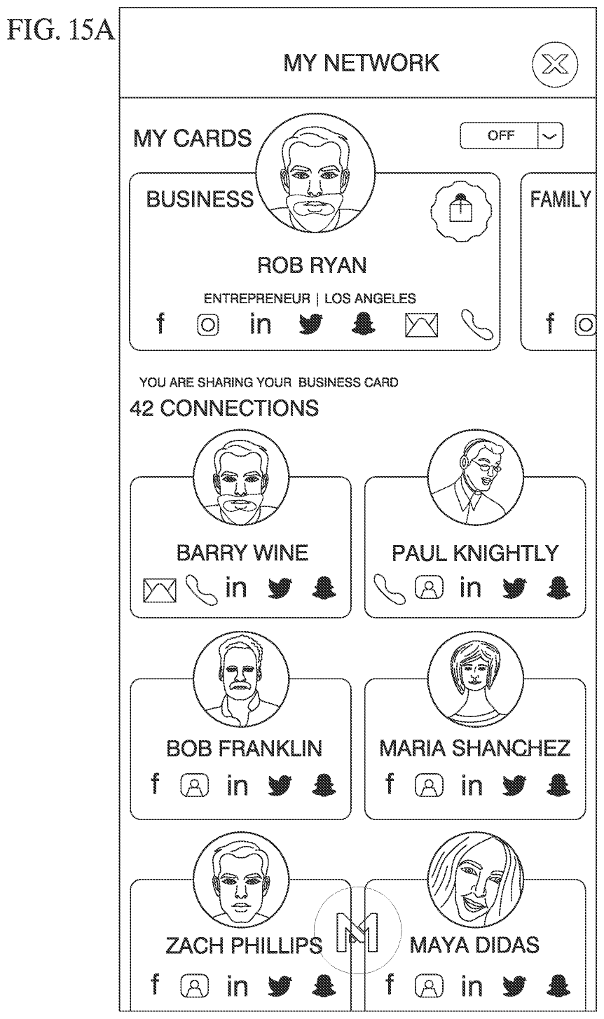

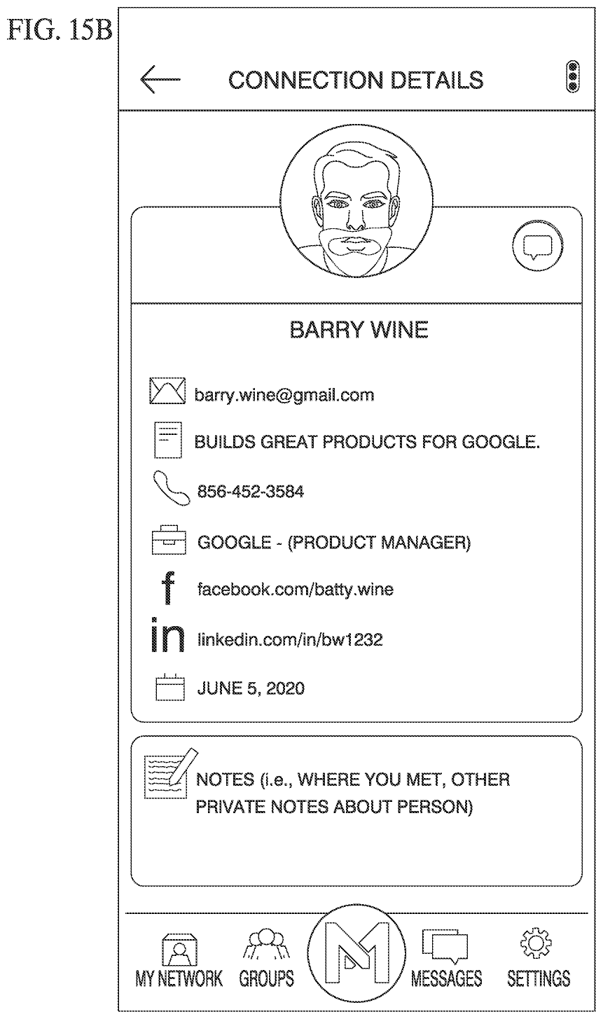

In an example, let's say you connect with a person on January 6th, 2021 and they're in your network. If they got a new phone in February of next year and changed it on their profile within Mydas, it will be updated automatically on our app for each user they connected with. FIGS. 15A-15B depict a series of stored connections displayed on a display of a user's mobile electronic device.

### Groups

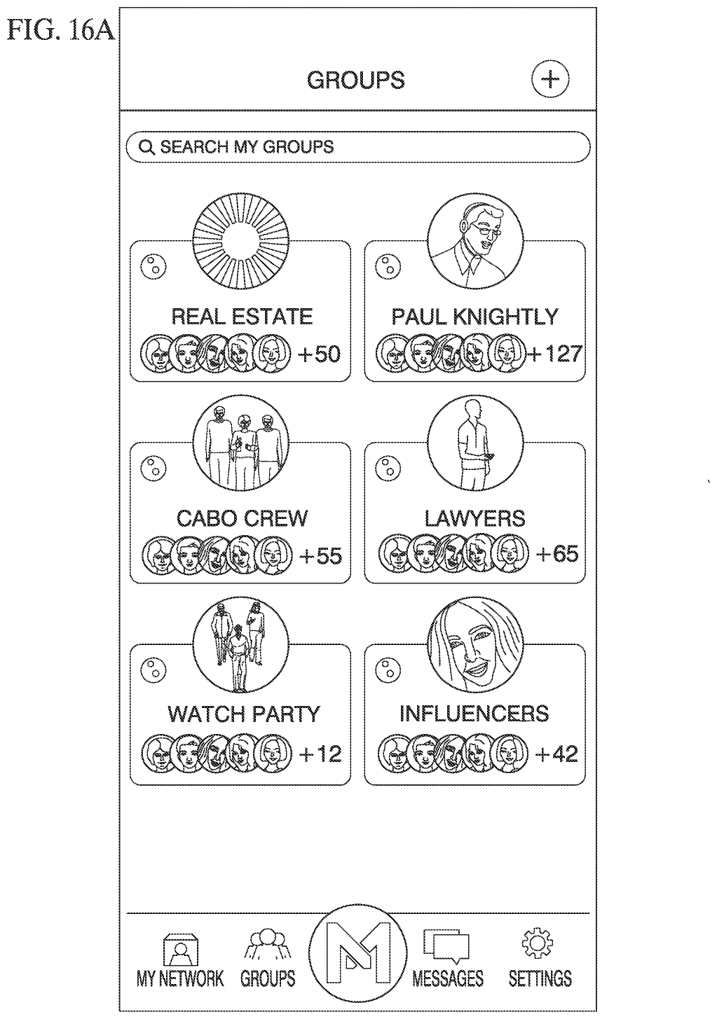

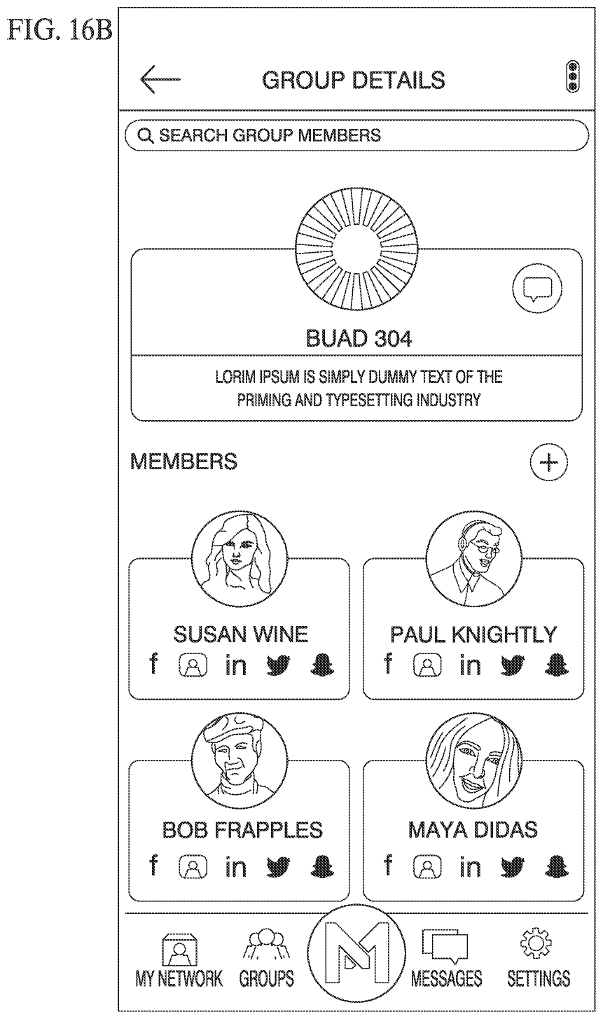

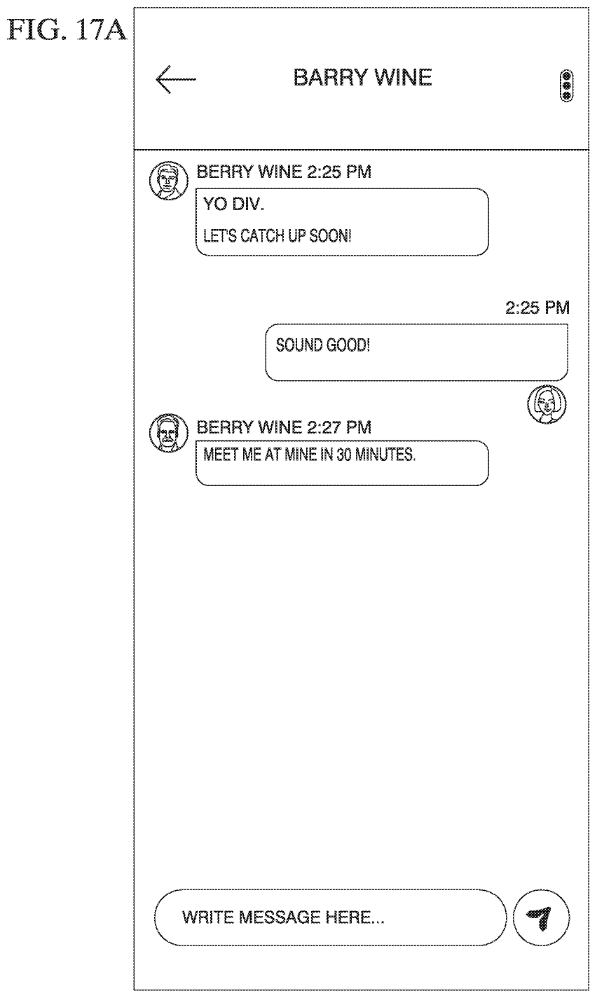

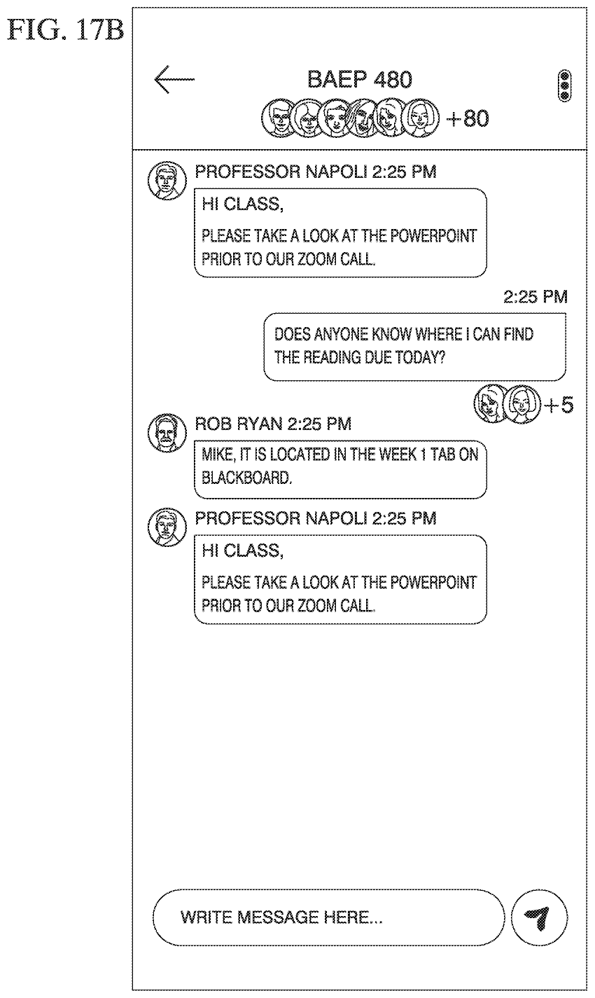

After connecting with people and building your network, an option may be to create groups for the users. Users may create groups with anyone they have connected with and may create a space where others may connect with each other/exchange information within that Group. There may be group conversations (In app Messaging). There may also be individual (directly) messaging each other on the platform once a connection is established. Members of a group may also have the ability to message between each other. FIGS. 16A-16B depict a series of groups displayed on a display of a user's mobile electronic device, each group containing at least one stored connection, and FIGS. 17A-17B depict a messaging feature between connected users.

### Exclusive Community

In one or more embodiments, a creator, brand, sports team, company, etc. may create an exclusive community within the app. “Exclusive community” access will be validated through email verification and verified partners will have a separate log in/sign up. Once signed up, a creator, company, brand, etc. will have the ability to turn a “digital wallet” or “card” into an exclusive community.

An exclusive community is a place where creators can build, manage and monetize their superfans, where brands can build, manage, monetize and reward their close knit customers, where companies can build, manage and monetize their users/followers/customers or even where sports teams can build, manage and reward their fanbase/attendees both on the go and virtually.

Within an exclusive community, a creator, brand, sports team, etc. will have the ability to sell digital experiences and their exclusive community will have a “digital store”. The digital store may contain various things, such as, for example, a 1 v 1 video call, Non-Fungible Tokens (NFTs), or requests like simple greeting for a friend. Members within a creator's exclusive community will have the ability to message between each other in addition to the creator. There may be a conversation (e.g., 1 v 1000) where the creator is only allowed to post. There may be a conversation where everyone is allowed to post, a conversation where only awarded members can post, or even a member's only conversation.

Members within an exclusive community have the ability to either receive connection requests or not receive connection requests. If they opt in, other members of the community can send them an invitation where they can either accept or reject the connection. If a user accepts the connection, they will then appear under the “My Network” screen. A creator, with a “digital wallet” or “card” attached to the community, can adjust information at all times and this information will be portrayed to the community in real time.

In one or more embodiments, a creator, brand, sports team, company or mydas member, etc. may have the following ways of sharing their exclusive community “digital wallet” or “card”:
1. Mydas Medallion (NFC): When a user holds their phone next to a medallion (either a mydas medallion or a medallion with their logo/color), mydas license plate, wearable tech, etc. they will be able to see all information on that creator's “digital wallet” or they may select a “join the community button” that uses deep deferred linking if the recipient doesn't have the app.
2. Bluetooth Proximity and Geofencing technology
3. QR Codes
4. Ultra-wideband (UWB) or another wireless standard
5. Link in bio

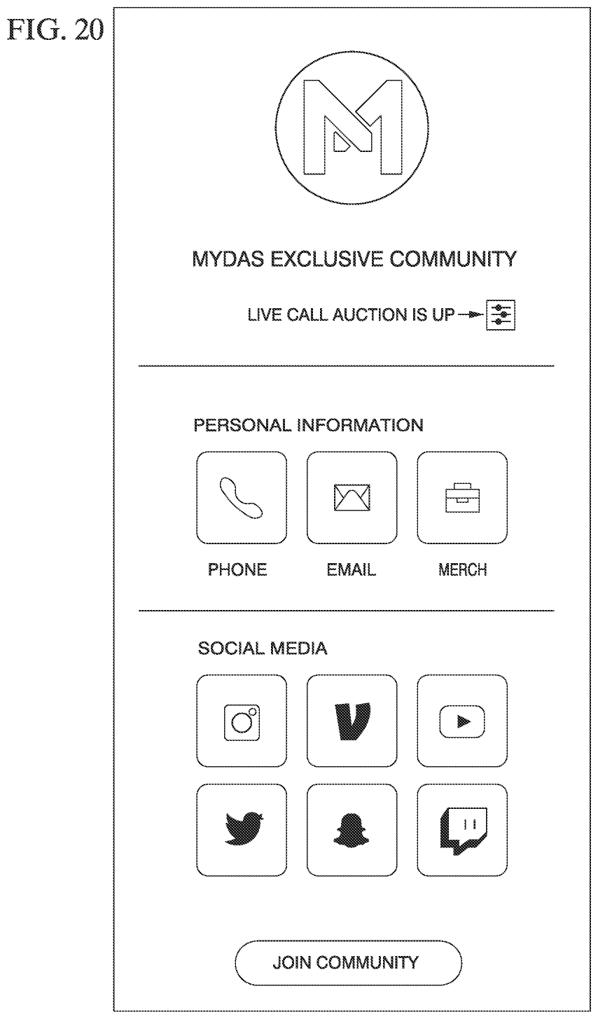

A partnered creator, brand, sports team, company, etc. can either place a “public exclusive community link” or a “private exclusive community” link on any social media platform, website, resume, etc. All traffic from these places will then have the ability to not only see any “information” on this “digital wallet” or “card”, but will also have the option to join the exclusive community. FIG. 20 depicts a mobile electronic device displaying a “join community” button.

A creator, brand, sports team, company, etc. with an exclusive community may appear in a community section within the app. Mydas members will have access to all of these communities listed and may join a community.

A creator, brand, sports team, company, etc. may sell non-fungible tokens within their exclusive community and a community member who purchases a non-fungible token will be able to upload it as part of a “digital wallet”, as a “digital wallet” or it will be located within their digital storefront. This digital storefront from a mydas member storefront may range from non-fungible tokens to experiences. A non-fungible token as a “digital wallet” or “card” can be connected to the medallion which then can provide exclusive access to various things such as entering a location, discounts, etc. using NFC technology or other wireless standard (e.g., Bluetooth TM).

Community members who contain either a branded Mydas Medallion (NFC) or a regular Mydas Medallion will be able to portray their communities on their “digital wallet” and may be rewarded for expanding a community through NFC, Bluetooth, QR, etc.

For example, in one or more embodiments, a company, such as an airline, may use a “digital wallet” for airline tickets. This will allow an airline to continuously keep track of rewards points, but also use their medallion or a “digital wallet” or “branded card” at their partnered brands. Airlines who partner with mydas, may also use NFC capabilities within the plane such as on an NFC monitor in front of their seat or paying for beverages.

In regards to the exclusive community link that will contain the “join the community button”, there are two different scenarios: (1) Users who do not have the app; or (2) Users who have the app. Under the first scenario, once an individual clicks on the “join community” button, the app uses deep deferred linking which leads the person to download the app and sign up. Once the user is signed up, they will automatically see that specific group(s)/community(ies). In the case of it being a creator or anyone involved in a Mydas partnership, they will appear under “My Network” as a connection as well. Under the second scenario, once the user clicks on “join community”, they will be directed to a “connect screen” where they have the ability to join or decline. Once they join the community, they can now start connecting with other members and are now part of the conversation as well.

### Events, Venues, Universities

Events, venues, festivals, universities, stadiums, companies, etc. may use Mydas for, for example, entrance verification, networking technology, and/or payments. Once the NFC is activated, it also may place individuals in specific groups or communities. For events, it can involve ticketing, where the ticket is connected as a “digital wallet” or “card” and the associated NFC which can be provided by the event holder. The event or venue may have a system on location that will verify a specific person according to information on a “digital wallet” or “card” within the application.

A creator, brand, sports team, company, etc., which has partnered with Mydas, has the ability to have branded Mydas NFC technology and sell it to their community. They can also provide exclusive access to events, concerts, stores, etc. for anyone who has their “branded” Mydas NFC product. For example, season tickets for sports teams may utilize an NFC product for entrance in addition to payment at the venue. Festivals, concerts, events, etc. can provide anyone who purchases a “ticket” the ability to upload it on Mydas as a “digital wallet” or “card” which is then attached to the NFC product, QR codes, proximity, user account, etc. In one or more embodiments, the app will utilize a unique identifier and security token that the server will validate, thus allowing verification and security before granting access to enter a venue, event, location, store, etc.

A brand, for example, may provide exclusive discounts to their branded NFC medallion holders which may be used at selective locations. Venues and event spaces will benefit from ticketing in Mydas due to its contactless way of exchanging information. In regards to payments, vendors and attendees will no longer have to pass around a physical credit card thus preventing the spread of any virus (COVID-19, etc.). Each vendor may have a system located at their location within the venue. Each attendee that connected their NFC wristband, wearable tech, medallion, etc. will also be on the discovery screen and may see an artist performing, event host, other vendors, etc. on the discovery screen. A partnered artist will be at the top of the discovery screen portraying their “digital wallet” or “card” or “exclusive community card” to attendees through Bluetooth proximity or may have NFC products located throughout the venue for brand exposure. A concert may even have an emergency account highlighted and on the top of a discovery screen, which provides easy access for attendees to reach help in case of an emergency.

Mydas users may have concert tickets as a non-fungible token and will be able to sell/list/trade them on the Mydas platform or to trade/sell the concert tickets through NFC, Bluetooth proximity, or QR codes with others. For regular Mydas members, if they are part of a community and are connected with other Mydas members, they will also be able to see what other communities those other members are part of, regardless of whether they are connecting through NFC, Bluetooth, QR codes, etc.

### Companies

Companies may use their branded NFC technology as a gateway into a “Mydas Contact Ecosystem” where employees who activate a “branded” medallion will either automatically get placed in a certain group or have the option to choose which groups or communities to be a part of upon activation. Email verification may be utilized to place individuals in their specified groups. Within their specified group, employees can now see others within their department, connect with them and begin messaging within the app. This group or community can include a calendar, a process for sending leads, and/or digital experiences, etc. In one or more embodiments, activation of the branded NFC may include either locking medallion (i.e., the NFC cannot be changed or reprogrammed) or password protection (e.g., strong password protection, not 32-bit). Upon activation, the strong/secure identifier is located (stored) in the NFC (i.e., the NFC stores attributes and an updated record of the associated groups or communities). Once an NFC is activated within the Mydas app, it may lock the NFC forever and the user may no longer be able to reprogram the NFC. A user may also be able to include a secure password that has, for example, a string of 1,000 or more characters, which provides enhanced security because such a long password cannot be guessed.

Companies may give employees branded medallions that can give them exclusive company access, such as entering various company locations, company benefits with their partners, etc.

Companies may also give branded mydas products out or sell them to either customers or others at events where they can join specific groups or communities within a company. This may give them exclusive access to certain things and/or to be part of a reward system.

Companies may use Mydas Bluetooth technology at their events as well. Every person who has their branded medallion also means they are on the discovery screen (whether it's through a check in or proximity technology), thereby creating a seamless and contactless networking experience.

Companies may also use Mydas sales technology for leads that can be exported. For example, real estate agents or sales agents. Mydas sales technology may allow employees to send leads to each other, provide analytics for a “digital wallet” or “card” and may be connected to a customer relationship management (CRM).

### Universities

Universities may provide their own branded medallions or NFC technology for university-wide access (e.g., dorm entrance, dining hall entrance, study rooms, etc.) and can also use it for payments university wide.

Once a student activates a medallion, they may also be able to see all of the students in their class, can connect with the other students for networking and group project purposes in addition to in-app messaging where they can communicate with their professor. Utilizing Bluetooth, NFC, or other wireless technology, this may be also a way of keep track of student attendance.

### Community Gamification

Fans or members of a community can earn points whether it's through Bluetooth, QR or NFC tap for referring members into the community or earning points through the digital experiences and/or engagement. They may be able to trade their points in for various things depending on one's reward system.

### Geofencing Technology:

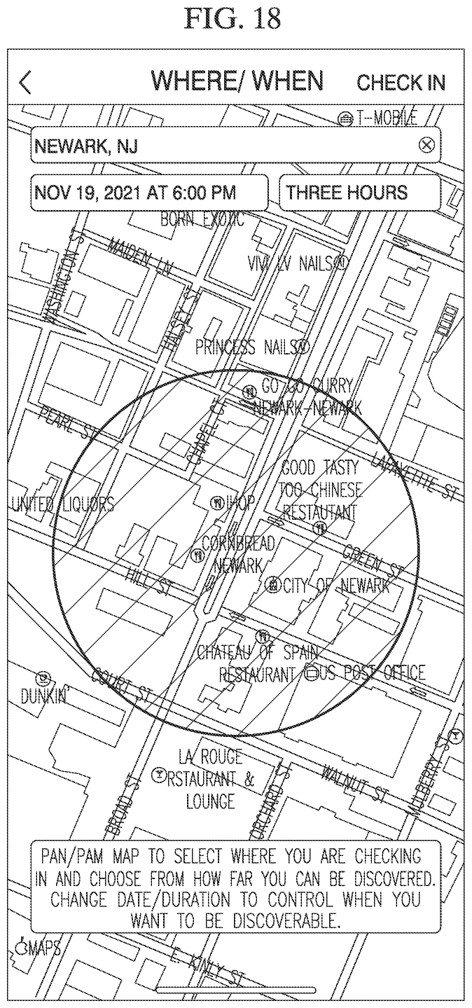

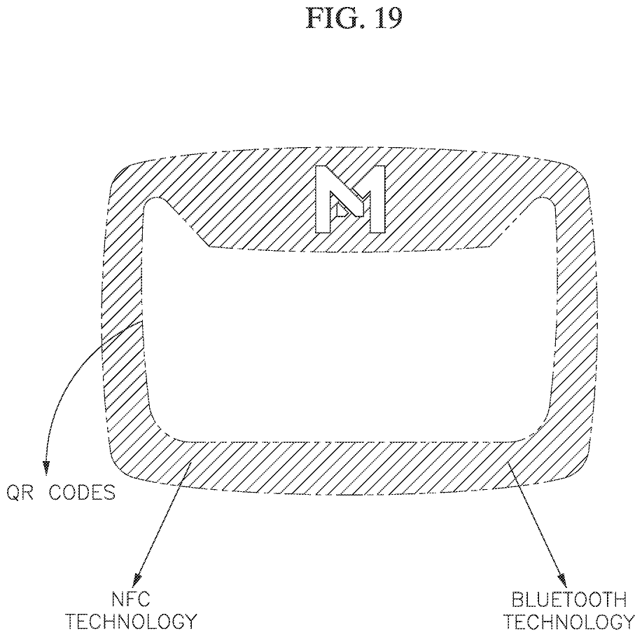

Utilizing Geofencing technology, any partnered creators, celebrities, artists, brands, companies, sports teams, etc. will be able to pick anywhere in the world where they can appear at the top of the discovery screen, portray their “digital wallet” or “card” or “exclusive community card”, provide the option to “join their community” or even sell digital experiences to any user who is located within the geofenced radius. FIG. 18 shows a display of a mobile electronic device displaying a geofenced area in which a user can be discovered by other users and a duration (e.g., 3 hours) during which the user is discoverable.

A brand, company, sports team, etc. can also check into a location, portray their “digital wallet” or “card” or “exclusive community card”, provide the option to “join their community” or even sell digital experiences to any user who is located within the geofenced radius. In one or more embodiments, the Mydas server searches or determines a list of everyone who is currently checked-in to an event and for whom their provided location falls within the geofenced radius.

### Check in Process

Creators, celebrities, artists, brands, companies, sports teams, etc. will be able to pinpoint a location anywhere in the world where they want to appear at the top of the discovery screen and that specific location. They also have the ability to search event venues, stadiums, stores, etc. through a search option and once an option is selected, it will form a geofence around that location of, for example, a radius or diameter of 500 meters. They will also be able to choose duration (start and end time) and have the ability to choose a future data & future location. In one or more embodiments, once a check-in expires, the user locations are not stored on the Mydas server. For example, creators can select the following: i. Geofenced area (e.g., 500 m); ii. Time (e.g., 24 hours); and iii. Future Date and Future Location.

Once a creator is checked in, every mydas member, brand, company, etc. within that area will be able to click on that creator and any information located on that “digital wallet” or “card” or “exclusive community” will be shown. An example of a use case are athletes at home games and away games or artists at their concert or even public speakers who want to engage with their fans right from their seat.

Creators, celebrities, artists, brands, companies, sports teams will also have the ability to choose their locations in advance. Creators, celebrities, artists, brands, companies, sports teams may provide certain experiences to a certain geographic location. For instance, an artist may only make an album available to users in New York or may only allow users in California to join their community or may even offer a non-fungible token to the east coast of the United States.

A Mydas member will also be able to check into a location within, for example, 50 m. For instance, at a networking event, tradeshow, concert, etc., the user can check in and will appear on the discovery screen for a set period, such as 4 hours (e.g., regular users (not creators) may check in to an event (or a location) within 50 m of the event (or location) based on the real-time and current location of the regular user's mobile electronic device, and they may remain checked in for 4 hours). They no longer need to launch the app to be discovered and receive requests. This is beneficial for conferences such as NFT conferences where users may have digital assets such as a Non-Fungible Token (NFT).

A brand, company, sports team, etc. can also check into a location. A brand will have the opportunity to set their “digital wallet” or “card” for more brand exposure and choose to be in public mode in which other Mydas members can discover them, see their information within that “digital wallet” or “card”, join that brand's community as well as portray/sell digital experiences. They also have the option to appear in other modes such as private where they can accept requests within the app.

Partnered creators, celebrities, artists, brands, companies, sports teams will also have the option to pay or bid for a larger geofence radius or duration. For instance, having a geofence around an entire state will be possible. The bigger the radius, the more they will need to pay or bid.

Mydas members will also have the option to pay or bid for a larger geofence radius or duration. Partnered creators, celebrities, artists, brands, companies, sports teams may be verified on the platform with the Mydas “M” logo on their selected “digital wallet” or “card”.

### Discovery Screen

The Discovery screen is a place where Mydas members can connect with each other utilizing, for example, Bluetooth proximity. Geofencing technology allows any partnered creators, celebrities, artists, etc. the ability to appear on the top of whichever locations in which they “checked in,” in the manner described above.

Any partnered creators, celebrities, artists, brands, companies, sports teams, etc., will be able to control which mode they're in for the discovery screen. If they're in public mode, any person in proximity (e.g., within range of a wireless standard, such as Bluetooth) will be able to see their attached “digital wallet” or “card” and the information on this “digital wallet” or “card”. The information can range from music, payment, social media, contact info, non-fungible tokens, experiences, communities in addition to the “join community” button that may be a deep deferred link. They also may be able to portray and sell items, non-fungible tokens, music, experiences, etc. Public mode may be particularly useful for brand exposure. Any of the partnered creators, celebrities, artists, etc., who appear in private mode will just portray the icons on their “digital wallet” or “card (e.g., one or more pieces of information may be omitted when in private mode).

In one or more embodiments, Mydas members will have the ability to pay or bid for a spot on the discovery screen. For instance, at an event (or a location) in which there are 1,000 attendees, Mydas members/users may have an option to pay a certain amount to be at a certain position on the screen (e.g., the top of the screen, such as a particular row or spot). Creators, celebrities, artists, brands, companies, sports teams, etc. will have the ability to pay or bid for a spot on the discovery screen.

A mydas member will be able to see any of the partnered creators, celebrities, artists, etc., and a brand, company, sports team will be able to see everyone in proximity. Mydas members and brands will be able to retrieve analytics on what others around them are “clicking on” in regards to the information on their digital passport.

### “Digital Wallet” or “Card”

Any partnered creators, celebrities, artists, brands, companies, sports teams, etc. or paid mydas members will have the ability to form any “digital wallet” or “card” into an exclusive community. Here they can add+sell digital experiences, sell NFTs, sell “requests”, update/add information relating to any social media platform, music, payment, etc.

A user has the ability to have unlimited “digital wallets” or “cards” and will contain a link with a long,secure token and may have another option to remove the long,secure token if they would like a friendly URL.

Community members who contain either a branded Mydas Medallion (NFC) or a regular Mydas Medallion will be able to portray (i.e., display) their communities on their “digital wallet” and may be rewarded for expanding a community through NFC, Bluetooth, QR, etc.

### Mydas License Plate, License Plate Frame×Mydas Discovery×NFC×QR Code

Individuals will have the ability to purchase a Mydas License Plate frame that contains NFC technology, QR Code technology, or Bluetooth Technology. In one or more embodiments, a user may activate the Mydas License Plate, or the Mydas License Plate Frame, with the Mydas App. The Mydas license plate and/or the Mydas license plate frame may then be attached to a vehicle (e.g., a bike, a car, a bus, etc.). FIG. 19 depicts an embodiment of a Mydas license plate frame including NFC technology, QR code technology, and/or Bluetooth technology.

The Mydas license plate or Mydas license plate frame will allow people at car shows to exhibit their car and provide an opportunity for more brand exposure. In use, a user may hold their phone to the NFC section of the Mydas license plate (or Mydas license plate frame) or scan the QR code and they will be able to access all information on that “digital wallet” or “card”.

Utilizing Mydas Discovery, cars will able to be discovered while driving using proximity technology and their “digital wallet” or “card” and modes (e.g., private, public, anonymous, off) will dictate what is displayed or otherwise accessible.

Partnered creators, celebrities, artists, brands, companies, sports teams or mydas members with access may also link an “exclusive community card” to their Mydas License Plate, which will allow fans or other people around them to join their community while driving.

### Mydas NFC Products Overall

Users may be able to locate and track each of their Mydas NFC products activity, and, in one or more embodiments, a user can activate unlimited NFC products per account.

### Web 3.0 & the Metaverse

Users are able to log in with any wallet (e.g., MetaMask™, etc.) or blockchain they are on and then will be automatically placed in that NFT's specific community within the app. Within this community, there will be threads that will be token gated to verify each owner and allowing users to not only showcase their social profiles, but also trade or sell their artwork, digital assets, non-fungible token or a card. Each member will have a digital storefront that will portray their non-fungible tokens or other digital assets.

Mydas members or a partnered creator, brand, sports team, company, etc. may have digital storefronts to host their digital assets and to display all of them within any community, trade them, sell them, etc.

Mydas members may be able to use mydas to portray their digital assets at any event which can be done through Mydas discovery or checking in feature or a QR code or NFC technology that can be showcased next to the digital art.

### Exclusive Community & Web 3.0

A creator, brand, sports team, company, etc. may be able to sell non-fungible tokens within their exclusive community on the app. In one example of a non-fungible transaction, an artist may sell a song or album in the form of a non-fungible token that will be located within their “digital storefront”. This may only be available to the members of this exclusive community.

In one or more embodiments, if a mydas member connects their blockchain wallet, they will automatically be placed into their token gated communities and threads. Their “digital storefront” may contain NFTs and these NFTs may provide exclusive event access. Using Near Field Communication, Bluetooth technology, and/or QR codes, members of an exclusive community may have a branded medallion or mydas medallion or NFC technology used at the venue of these events. There may be a reader at these events that confirm whether or not they contain a non-fungible token associated with that specific community. A message may appear on the screen that verifies their membership. For example, members of Bored Ape Yacht Club may have a Bored Ape Yacht Club medallion that gives them exclusive access and benefits around the world for being a member of this community. They may have access to certain events and at these venues they may use

NFC, Bluetooth, and/or QR codes to verify that they contain a non-fungible token associated with a specific community.

### Metaverse

In one or more embodiments, users will be able to earn fungible tokens within games or assets within the metaverse that will be able to be converted into crypto currency and can be shared with their “digital wallet” or “card” through NFC, Bluetooth proximity, QR codes, etc.

In one or more embodiments, “digital wallets” and NFC technology, Bluetooth or other wireless proximity (e.g., ultra-wide band (UWB), and/or QR codes, may be utilized not only to share socials, but to make payments using cryptocurrency, trade digital assets, trade crypto currencies to others and entrance verification method for exclusive NFT events for members.

The processes and methods disclosed herein may be implemented using a shared processing device, individual processing devices, or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions.

The described embodiments or any part(s) or function(s) thereof, may be implemented using hardware, software, or a combination thereof, and may be implemented in one or more computer systems or other processing systems. A computer system for performing the operations of the described embodiments and capable of carrying out the functionality described herein can include one or more processors connected to a communications infrastructure (e.g., a communications bus, a cross-over bar, or a network). Various software embodiments are described in terms of such an exemplary computer system. After reading this description, it will become apparent to a person skilled in the relevant art(s) how to implement the embodiments using other computer systems and/or architectures.

The foregoing description of the preferred embodiments has been presented for purposes of illustration and description. It is not intended to be exhaustive or to limit the embodiments to the precise form or to exemplary embodiments disclosed. Obviously, many modifications and variations will be apparent to practitioners skilled in this art. Similarly, any process steps described might be interchangeable with other steps in order to achieve the same result. The embodiments were chosen and described in order to best explain the principles of the embodiments and its best mode practical application, thereby to enable others skilled in the art to understand the various embodiments and with various modifications as are suited to the particular use or implementation contemplated. It is intended that the scope of the embodiments be defined by the claims appended hereto and their equivalents. Reference to an element in the singular is not intended to mean “one and only one” unless explicitly so stated, but rather means “one or more.” Moreover, no element, component, nor method step in the described disclosure is intended to be dedicated to the public regardless of whether the element, component, or method step is explicitly recited in the following claims. No claim element herein is to be construed under the provisions of 35 U.S.C. Sec. 112, sixth paragraph, unless the element is expressly recited using the phrase “means for . . . . ”

In addition, the conjunction “and” when used in the claims is meant to be interpreted as follows: “X, Y and Z” means it can be either X , Y or Z individually, or it can be both X and Y together, both X and Z together, both Y and Z together, or all of X, Y, and Z together. It should be understood that the figures illustrated in the attachments, which highlight the functionality and advantages of the described embodiments, are presented for example purposes only. The architecture of the described embodiments are sufficiently flexible and configurable, such that it may be utilized (and navigated) in ways other than that shown in the accompanying figures.

Furthermore, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the described embodiments in any way. It is also to be understood that the steps and processes recited in the claims need not be performed in the order presented.

Also, it is noted that the embodiments may be described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. A process or method may be implemented with a processor, or similar device, or any combination of hardware and software.

Moreover, a storage medium may represent one or more devices for storing data, including read-only memory (ROM), random access memory (RAM), magnetic disk storage mediums, optical storage mediums, flash memory devices and/or other machine-readable mediums, processor-readable mediums, and/or computer-readable mediums for storing information. The terms “machine-readable medium”, “computer-readable medium”, and/or “processor-readable medium” may include, but are not limited to non-transitory mediums such as portable or fixed storage devices, optical storage devices, and various other mediums capable of storing, containing or carrying instruction(s) and/or data. Thus, the various methods described herein may be fully or partially implemented by instructions and/or data that may be stored in a “machine-readable medium”, “computer-readable medium”, and/or “processor-readable medium” and executed by one or more processors, machines and/or devices. Moreover, a microprocessor, or similar device may have internal or external memory associated with it.

The various features of the embodiments described herein can be implemented in different systems without departing from the embodiments. It should be noted that the foregoing embodiments are merely examples and are not to be construed as limiting the embodiments. The description of the embodiments is intended to be illustrative, and not to limit the scope of the claims. As such, the described teachings can be readily applied to other types of apparatuses and many alternatives, modifications, and variations will be apparent to those skilled in the art.

What is claimed is:

1. A method of securely exchanging information, the method comprising:
displaying, on a display of a first mobile electronic device, a profile associated with a user of a second mobile electronic device, the profile omitting at least one omitted item of information;
transmitting, from the first mobile electronic device, a connection request to the second mobile electronic device; and
displaying, on the display of the second mobile device, the profile including the at least one omitted item of information in response to the user of the second mobile electronic device accepting the connection request.

2. The method of claim 1, further comprising displaying, on the display of the first mobile electronic device, a connect button that links to a downloadable application with deferred deep linking.

3. The method of claim 1, wherein the transmitting of the connection request includes transmitting a second profile associated with a user of the first mobile electronic device.

4. The method of claim 3, further comprising displaying, on the display of the first electronic device, a group of digital cards comprising of a business profile card and a social profile card, and wherein the second profile is selected from the group of digital cards.

5. The method of claim 4, wherein the transmitting the second profile to the second mobile electronic device includes transmitting a URL token to the second mobile electronic device, and wherein the URL token, when accessed by the second mobile electronic device, displays the second profile on a display of the second mobile electronic device.

6. The method of claim 1, further comprising displaying, on the display of the first mobile electronic device, a plurality of groups, each group of the plurality of groups containing at least one user profile.

7. The method of claim 1, further comprising displaying, on a display of the first mobile electronic device, a plurality of stored connections each including a connection date.

8. The method of claim 1, further comprising selecting, from an options menu displayed on the display of the first mobile device, a private mode.

9. The method of claim 1, further comprising selecting, from an options menu displayed on the display of the first mobile device, an anonymous mode.

10. The method of claim 1, wherein the at least one omitted item of information is personal information selected from the group consisting of a name, a phone number, an email address, and a job title.

11. The method of claim 1, wherein the at least one omitted item of information is a clickable link of a social media profile.

12. The method of claim 1, wherein the at least one omitted item of information is a profile picture.

13. The method of claim 1, wherein the displaying the profile is in response to the first mobile electronic device moving in close proximity to a near field communications (NFC) tag on the second mobile electronic device.

14. The method of claim 1, wherein the displaying the profile is in response to the first mobile electronic device being within range of a short-range wireless device of the second mobile electronic device.

15. The method of claim 1, wherein the displaying the profile is in response to the first mobile electronic device scanning a QR code displayed on a display of the second mobile electronic device.

16. A method of exchanging information, the method comprising:
displaying, on a display of the first mobile electronic device, a profile associated with a user of a second mobile electronic device in response to the first mobile electronic device being within a geofenced area set by the second mobile electronic device; and
joining, by the first mobile electronic device, an exclusive community associated with the user of the second mobile electronic device.

17. The method of claim 16, wherein the displaying the profile further comprises displaying the plurality of profiles within the geofenced area and within a specified time period.

18. The method of claim 16, wherein the checking the first mobile electronic device into the event comprises a process selected from the group consisting of tapping an NFC tag on the first mobile electronic device to an NFC reader, scanning, by the first mobile electronic device, a QR code, and moving the first mobile electronic device into range of a short-range wireless device at the event.

19. The method of claim 16, further comprising receiving, by the first mobile electronic device a non-fungible token (NFT) associated with the exclusive community.

20. A method of accessing exclusive content, the method comprising:
activating or tapping an NFC medallion on a mobile electronic device, the branded NFC medallion being associated with a community; and
displaying, on a display of the mobile electronic device, a plurality of members of the community.
